(19) United States
(12) Patent Application Publication
(10) Pub. No.: US 2003/0101267 A1
(43) Pub. Date: May 29, 2003

(54) Peer-to-peer caching network

(76) Inventors: Mark R. Thompson, Chandler, AZ (US); Nathan F. Raciborski, Jackson, WY (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(21) Appl. No.: 10/002,222

(22) Filed: Nov. 28, 2001

(51) Int. Cl. G06F 15/16

(52) U.S. Cl. 709/227; 709/217

(57) ABSTRACT

A peer-to-peer caching system can be utilized to cache a file residing on a content providing computer. The cached file can be stored on a caching computer. A computer that requests a file from a content providing computer can be rerouted to the caching computer so as to obtain the file.

This invention relates generally to peer-to-peer networks and more specifically, to caching files in a peer-to-peer network.

### BACKGROUND

It is currently popular to exchange data files across a computer network, such as the Internet. For example, one prevalent practice is to exchange music files across peer-to-peer networks in which users establish a peer-to-peer relationship with other users across a network. Thus, users can gain copies of music files from their counterparts who are located remotely.

With video files, however, the bandwidth required to download such files is extensive. Therefore, the exchange of such files in a peer-to-peer network can place a substantial burden on the computer supplying the video file. Not only does this increase network traffic, it also makes the computer supplying the video file unavailable for communication or exchange of files with other computers while the video file is being downloaded. Furthermore, the transmission of the video file across the network places a burden on additional network resources by requiring them to convey the data file packets through the network. Finally, even the facility where the receiving computer is located is impacted by the download of the video file to it as the bandwidth for that facility is impacted by the download.

In educational institutions, such as universities, the download of music by students places significant burdens on the university's computing resources. As a result, some universities have implemented restrictions preventing the download of such material. While audio files have already caused such an impact on the computing resources, the download of video files in the future will place a significantly greater burden on such computing systems due to the much greater size of such video files.

Thus there is a need for a system that can alleviate the significant impact caused by downloading files, specifically in a peer-to-peer network.

### SUMMARY

In one embodiment of the invention a method is provided for caching data files in a peer-to-peer network. The method is comprised of providing a first computer; providing a second computer; establishing a peer-to-peer network relationship between the first computer and the second computer; conveying a file from the first computer to the second computer; and caching that file.

Furthermore the caching can be performed at a caching computer, such as a computer located at a facility having heavy traffic for that type of file.

In addition, once a file has been cached, a third computer can be directed to that cached file by the original file provider. Alternatively, a computer disposed between the first and third computer can intercept a request for the file and direct the third computer to the file stored in the cached computer.

In one embodiment of the invention a network such as the Internet can be utilized to provide the medium for establishing the peer-to-peer relationship between the various computers.

In another embodiment of the invention a computer readable medium having computer executable instructions can be utilized to perform the various caching functions.

### BRIEF DESCRIPTION OF THE DRAWINGS

FIG. 1 illustrates a flowchart for a method according to one embodiment of the invention.

FIG. 2 illustrates a flowchart for an embodiment of the invention for caching files in a peer-to-peer network.

FIGS. 3A and 3B illustrate a flowchart for one embodiment of the invention so as to accomplish peer-to-peer caching of a file.

FIG. 4 illustrates an embodiment of the invention for establishing a caching network in a peer-to-peer network.

FIG. 5 illustrates another embodiment of the invention for providing an intermediate computer between computers in a peer-to-peer network.

FIG. 6 illustrates an embodiment of the invention for providing an article of manufacture to accomplish the functions of caching a file.

### DESCRIPTION

In peer-to-peer networking, a substantial burden is placed on the resources of the computer that provides a file as well as the network in general. In the exchange of video files, for example, the substantial size of these files places a great burden on the resources of the computing system. Even with substantially smaller files such as audio files, the burden can be significant.

With the advent of streaming audio and video, peer-to-peer networks provide yet another avenue for streaming this type of file. Thus, a user can establish a peer-to-peer relationship with a provider of a content file, such as a movie or audio file, and download the data for display or listening.

As video streaming networks develop, greater and greater resources will be disposed at content providing computers for downloading to customer computers. When these computers are operated in a peer-to-peer relationship, it will not be commercially feasible to provide the content files from the origin computer for a particular file. Due to the heavy traffic that will result for some content files, the provider computer will incur heavy traffic requesting data content. While the peer-to-peer relationship facilitates the downloading of the files, the lack of bandwidth to accommodate the various requests will be a limiting factor in the feasibility of such systems. Therefore, an embodiment of the invention provides a solution that accommodates peer-to-peer relationships yet reduces the stresses placed on a computing system in downloading files.

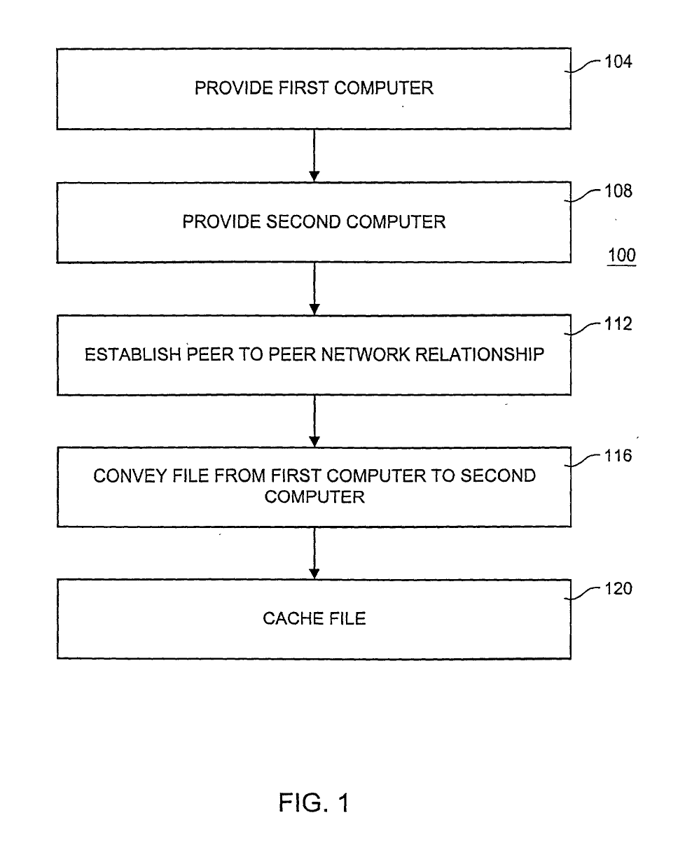

In FIG. 1, flowchart 100 illustrates a method according to one embodiment of the invention. In block 104 a first computer is provided. This first computer could be a content providing computer such as a computer that commercially supplies movies for streaming to customers. In block 108 a second computer is provided. For example, such a computer can be a computer of a home user who desires to obtain a movie for viewing. In block 112 a peer-to-peer network relationship is established between the first computer and the second computer. As appreciated by one of ordinary skill in the art, such a peer-to-peer relationship allows each computer to access files in directories of the opposing computer. Thus, in the example given above, a customer requesting a video file at his or her home can review the files available on a directory of a content providing computer via the peer-to-peer network connection.

Once a peer-to-peer network relationship is established between the first and second computers, a file can be requested by the second computer from the first computer. As shown in block 116, this file can then be conveyed from the first computer to the second computer. For example, a commercially available file on the first computer for a movie can be conveyed to the second computer for viewing on the second computer. In block 120 the file can be cached for future requests of that same file.

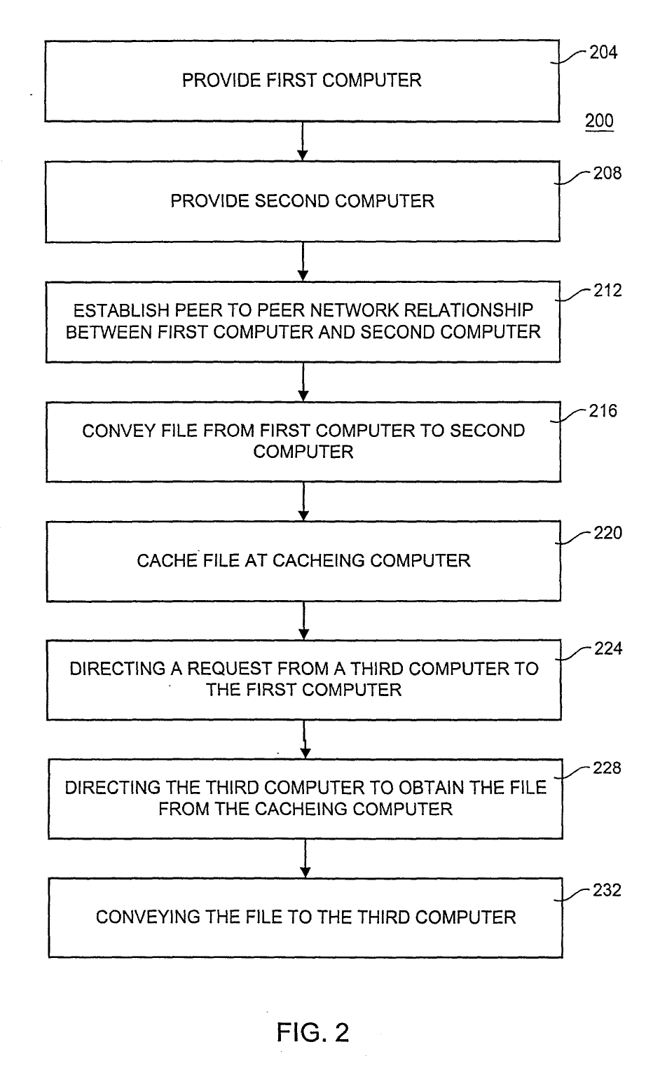

FIG. 2 illustrates yet another embodiment of the invention as illustrated by flowchart 200. Again, in FIG. 2, a first computer is provided in block 204. A second computer is also provided as shown in block 208. The peer-to-peer relationship is established between the first and second computers as noted in block 212 and a file is conveyed from the first computer to the second computer as shown in block 216. The file is then cached at a caching computer as shown in block 220. This caching computer can be a computer that is physically separate from the first computer which provides the file. For example, the caching computer can be disposed at a location that will improve the quality of service provided by a commercial streaming network. As one example, if a content providing computer is located in the southeastern part of the United States, and a substantial percentage of the computers that will be requesting a file from that computer are located on the West Coast of the United States, a caching computer can be provided in proximity to that audience by locating the caching computer on the West Coast, as well. Similarly, due to the large audience available through computing systems of large universities, a caching computer can be located in proximity to that university audience. Thus, a content provider can cache popular files on a caching computer located in close proximity (physical and/or network proximity) to the requesting audience.

Furthermore, rather than determining the audience that will be requesting a file, multiple caching computers can be disposed throughout the country. Thus, as a user requests a file from a content providing computer, the file can as a matter of course be cached at the most proximate caching computer for that user. Thus, in such an example, the initial request of the file serves as the trigger for causing the file to be cached at a caching computer.

In block 224 a third computer directs a request for the file to the first computer. The first computer receives the request from the third computer and directs the third computer to obtain the file from the caching computer as illustrated by block 228. In block 232 the file is conveyed to the third computer which originally requested it. Thus, the third computer is able to obtain the desired file while the first computer is able to accommodate additional requests without having to download the file and preventing additional requests from being serviced by the first computer. In this way, the first computer can accommodate a greater number of requests from other computers while also allowing those computers to obtain the desired file from caching computers. The third computer can establish a peer-to-peer relationship with the caching computer. Alternatively, the third computer could establish a client-server relationship with the caching computer.

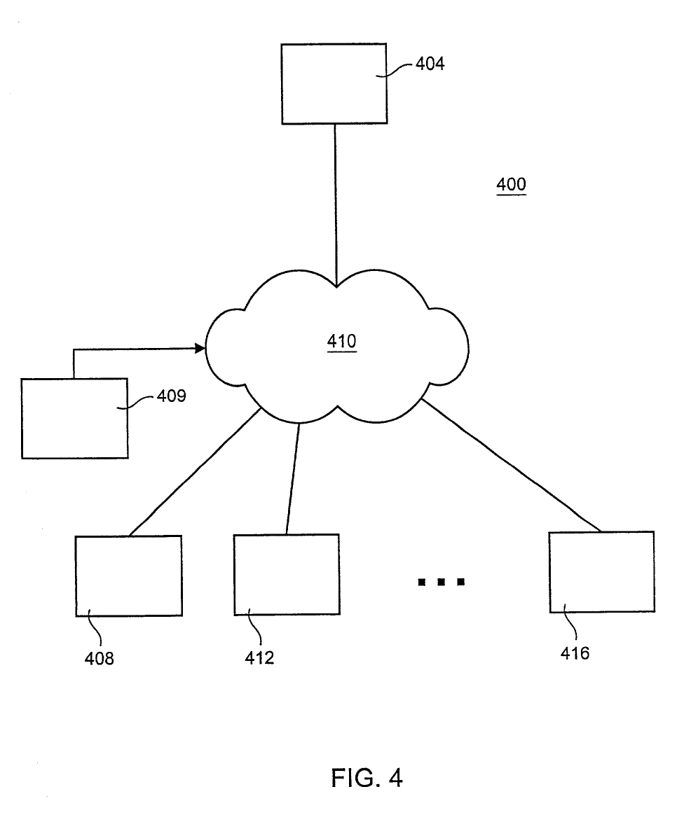

FIG. 4 illustrates a system for accomplishing one embodiment of the invention. In FIG. 4, system 400 illustrates a first computer 404 and a second computer 408 which can communicate via network 410, such as via the Internet. In addition, a third computer 412 and fourth computer 416 are shown in communication with the network. Any number of computers can be connected via this network system. A caching computer 409 is also shown connected to the network 410. As noted above, the first computer 404 can establish a peer-to-peer relationship with the second computer 408. A file requested by the second computer 408 from the first computer 404 can be downloaded via the network 410 to the second computer 408. Furthermore, the requested file can then be cached at the caching computer 409 by conveying the file to the caching computer, for example, via File Transfer Protocol (FTP). When a third computer 412 requests the same file from the first computer 404, the first computer 404 can direct the third computer 412 to obtain the file from the caching computer 409. Similarly, this can be repeated for the fourth computer 416. The ellipsis illustrates that any number of computers can be connected via the network to the first computer 404 as well as the caching computer 409. Thus, the system 400 can free up computing resources so as not only to provide the desired file to a requesting computer from the caching computer but also to accommodate additional requests for a file at the first computer. In this fashion, goals of providing the file through the network and facilitating high traffic across the network can be accommodated.

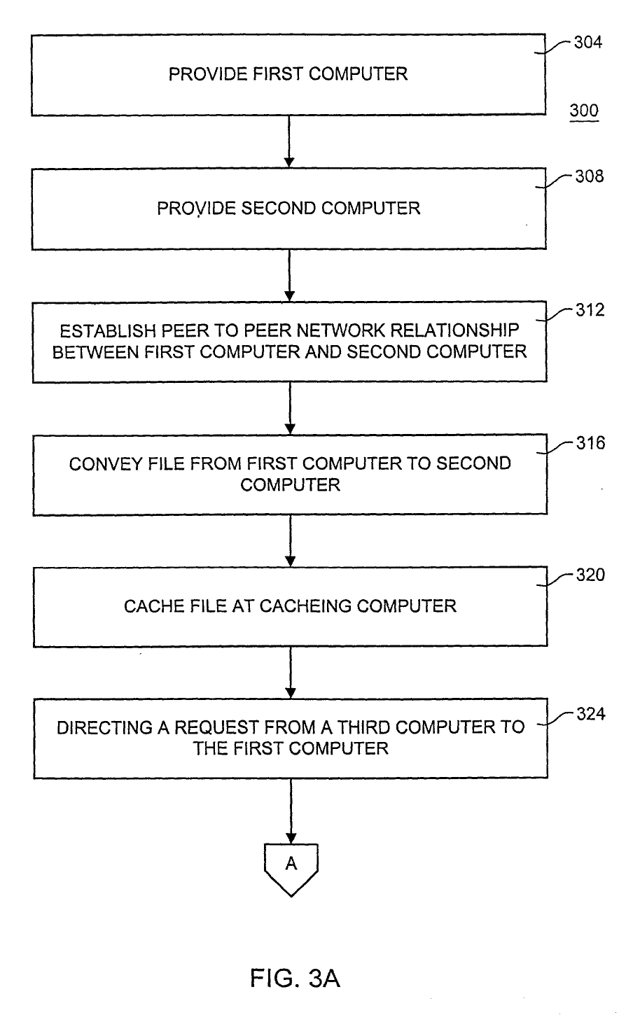

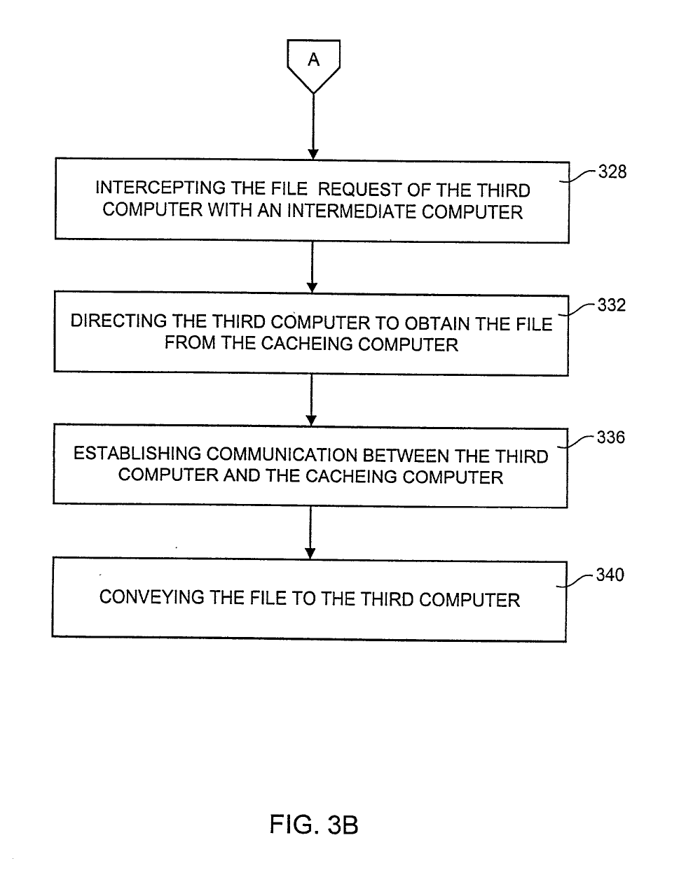

FIGS. 3A and 3B illustrate a flowchart 300 for yet another embodiment of the invention. In FIG. 3A, a first computer is provided in block 304. A second computer is also provided as shown in block 308. A peer-to-peer network relationship is established between the first computer and the second computer as shown in block 312. A file is conveyed from the first computer to the second computer as shown in block 316. This file is also cached at a caching computer as illustrated in block 320. A request is then directed from a third computer to the first computer. In block 328 of FIG. 3B, the request for the file initiated by the third computer and directed to the first computer is intercepted via an intermediate computer. Upon intercepting the request for the file, the intermediate computer can determine (for example, via a look up table) that the requested file is stored at the caching computer. The intermediate computer can then respond to the request of the third computer indicating that the third computer can obtain the file from the caching computer as illustrated in block 332. In block 336, communication is established between the third computer and the caching computer. Then, in block 340, the file is conveyed to the third computer from the caching computer.

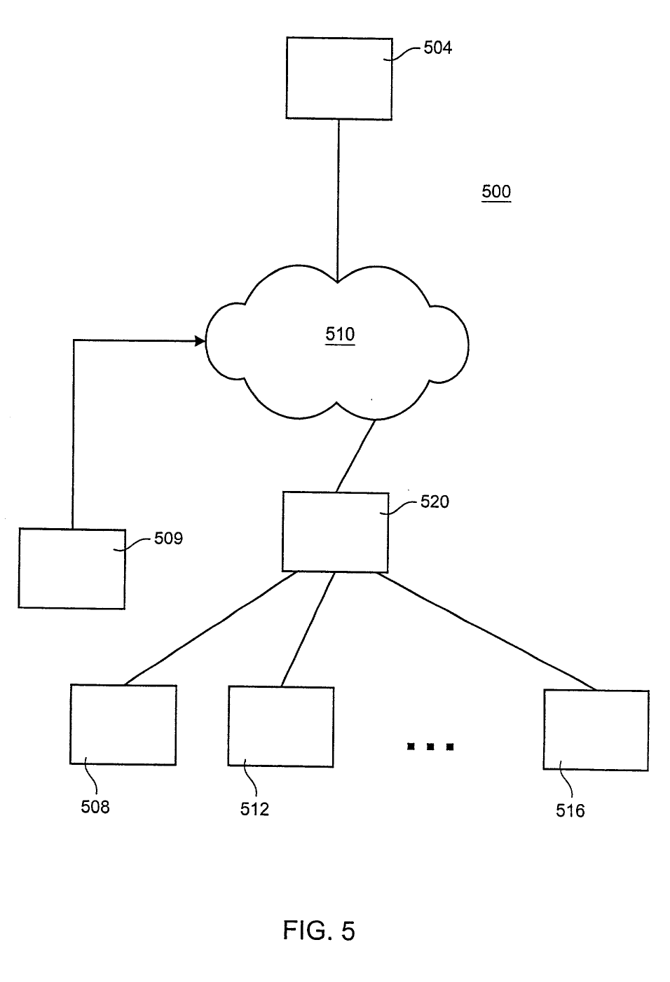

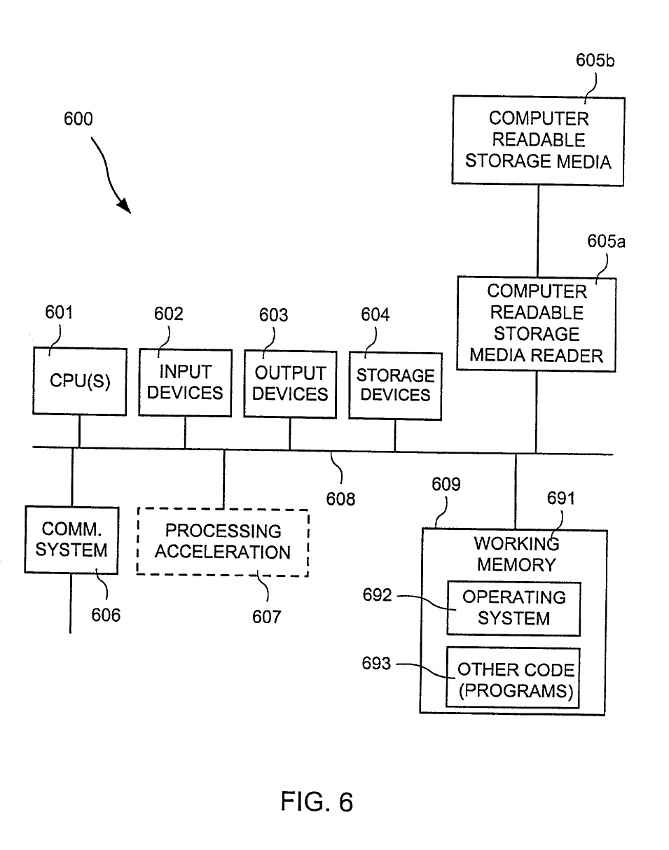

This embodiment of the invention can be illustrated further in FIG. 5. In FIG. 5 a system 500 is shown having a first computer 504 which stores data content for downloading to peer computers. A second computer 508 and third computer 512 as well as additional computers, including fourth computer 516, are connected to an intermediate computer 520 which is shown connected to a network, such as the Internet 510. In addition, a caching computer 509 is also coupled to the network. The intermediate computer can serve as a router (???) which routes traffic intended for a public network, such as the Internet, to the network for coupling with other computers connected to the network. Thus, an internal network of computers as can be illustrated by computers 508, 512 and 516 can be connected to a public network. The intermediate computer 520 thus sees requests for files transmitted through it as an intermediary. Consequently, when a peer-to-peer relationship is established between the first computer 504 and the third computer 512 requesting a file which has been stored to the caching computer 509, the intermediate computer 520 can respond to the third computer so as to direct it in obtaining the requested file from the caching computer. In this way, the resources of the first computer are saved and the requested file can successfully be downloaded to the requesting computer 512. In some instances, the intermediate computer can also serve as the caching computer. In a university setting, for example, this would significantly reduce traffic on the university's Internet connections.

While in one embodiment, the file can be cached at the time it is requested by the second computer, in other embodiments, the file could be cached during off-peak hours so as to not occupy bandwidth that is more valuable during peak hours. Thus, instead of caching a file during the peak hours, one could cache it during off-peak hours when the downloading to the caching computer would impose less of a burden on the system. In one embodiment of the invention, only designated peers would be able to access the cached content on the caching computer. Thus, a system could be implemented that could determine whether a requesting computer would be entitled to obtain a file from the caching computer. If the requesting computer were not allowed to obtain the file from the caching computer, the file could be downloaded from the origin computer for that content.

In one embodiment of the invention, file transfer protocol (FTP) could be utilized to move files between peers. Thus, when a peer requested a file from another peer, the requested file could be downloaded to the requesting peer via the FTP.

In a peer-to-peer architecture, searching and cataloging modules can be designed by third parties and integrated into the peer-to-peer system. Thus, since new formats of files are constantly being invented, the peer-to-peer system could be extended to those new formats so as to allow a third party to be able to update the system in an easy manner. This would facilitate making the search function modular.

For example, a plug-in for each peer-to-peer node could gather search information for its content and allow searching for content on other peer-to-peer nodes. Upon start-up or update of any directories that store content objects, the server could gather information about the objects. When doing a search, a list of possible plug-ins could be available to search with. Only other nodes that supported that plug-in would be searched. The plug-in search screen would have parameter fields unique to that format of content. For example a search screen for MP3 files would have parameter fields for encoding bit rate, length in time, artist, and title. The search results could be displayed by the plug-in. When two nodes connect to one another, they could then communicate which plug-ins they support. Thus, clusters of computers can be developed to support centralized directories.

A peer-to-peer group can facilitate publishing or mirroring of sites, volumes, directories, or content objects among a peer group. Currently, it is difficult to distribute audio, video, or graphics files among friends. Most email programs reject attachments that are larger than 2 MB today. Thus, according to one embodiment of the invention, directories, volumes, or objects could be pushed to predefined peers in a distribution list. Thus, automatic download by peers could be accomplished from a distribution list. Similarly one could mirror a mirror of a content providing computer such that a chain of mirror sites would be the progeny of a single parent site. A user could designate sites, volumes, directories, or content objects that are mirrored or published to a list of other users. Changes to the parent site could also be copied to the sibling sites. One could also operate a normal peer-to-peer without any mirroring. Thus, a parent content providing computer could be mirrored to a first generation of mirroring computers. One of the first generation of mirroring computers can then mirror the parent computer through the first generation of mirrored computers to a second generation of mirroring computers. The process could then be repeated yet again. In addition, the parent could be notified of a subsequent mirror.

System 600 is shown comprised of hardware elements that are electrically coupled via bus 608, including a processor 601, input device 602, output device 603, storage device 604, computer-readable storage media reader 605a, communications system 606 processing acceleration (e.g., DSP or special-purpose processors) 607 and memory 609. Computer-readable storage media reader 605a is further connected to computer-readable storage media 605b, the combination comprehensively representing remote, local, fixed and/or removable storage devices plus storage media, memory, etc. for temporarily and/or more permanently containing computer-readable information, which can include storage device 604, memory 609 and/or any other such accessible system 600 resource. System 600 also comprises software elements (shown as being currently located within working memory 691) including an operating system 692 and other code 693, such as programs, applets, data and the like.

System 600 is desirable as an implementation alternative largely due to its extensive flexibility and configurability consistent with that already enabled. Thus, for example, a single architecture might be utilized to implement one or more computers that can be further configured in accordance with currently desirable protocols, protocol variations, extensions, etc. However, it will be apparent to those skilled in the art that substantial variations may well be utilized in accordance with more specific application requirements. For example, one or more system elements might be implemented as sub-elements within a system 600 component (e.g. within communications system 606). Customized hardware might also be utilized and/or particular elements might be implemented in hardware, software (including so-called “portable software,” such as applets) or both. Further, while connection to other computing devices such as network input/output devices (not shown) may be employed, it is to be understood that wired, wireless, modem and/or other connection or connections to other computing devices might also be utilized. Distributed processing, multiple site viewing, information forwarding, collaboration, remote information retrieval and merging, and related capabilities are each contemplated. Operating system utilization will also vary depending on the particular host devices and/or process types (e.g. computer, appliance, portable device, etc.) and certainly not all system 600 components will be required in all cases.

While various embodiments of the invention have been described as methods or apparatus for implementing the invention, it should be understood that the invention can be implemented through code coupled to a computer, e.g., code resident on a computer or accessible by the computer. For example, software and databases could be utilized to implement many of the methods discussed above. Thus, in addition to embodiments where the invention is accomplished by hardware, it is also noted that these embodiments can be accomplished through the use of an article of manufacture comprised of a computer usable medium having a computer readable program code embodied therein, which causes the enablement of the functions disclosed in this description. Therefore, it is desired that embodiments of the invention also be considered protected by this patent in their program code means as well.

It is also envisioned that embodiments of the invention could be accomplished as computer signals embodied in a carrier wave, as well as signals (e.g., electrical and optical) propagated through a transmission medium. Thus, the various information discussed above could be formatted in a structure, such as a data structure, and transmitted as an electrical signal through a transmission medium or stored on a computer readable medium.

It is also noted that many of the structures, materials, and acts recited herein can be recited as means for performing a function or steps for performing a function. Therefore, it should be understood that such language is entitled to cover all such structures, materials, or acts disclosed within this specification and their equivalents.

It is thought that the apparatuses and methods of the embodiments of the present invention and many of its attendant advantages will be understood from this specification and it will be apparent that various changes may be made in the form, construction, and arrangement of the parts thereof without departing from the spirit and scope of the invention or sacrificing all of its material advantages, the form herein before described being merely exemplary embodiments thereof.

What is claimed is:

1. A method of caching data files comprising:
providing a first computer;
providing a second computer;
establishing a peer to peer network relationship between said first computer and said second computer;
conveying a file from said first computer to said second computer;
caching said file.

2. The method as described in claim 1 wherein said caching said file comprises:
caching said file at a caching computer.

3. The method as described in claim 1 wherein said caching said file comprises:
caching said file at a location where said second computer is located.

4. The method as described in claim 1 and further comprising:
receiving a request for said file at said first computer from a third computer.

5. The method as described in claim 4 and further comprising:
directing said third computer to obtain said file from said caching computer.

6. The method as described in claim 5 and further comprising:
establishing communications between said third computer and said caching computer; and
conveying said file to said third computer.

7. The method as described in claim 1 and further comprising:
providing an intermediate computer to facilitate communications between said first computer and said third computer;
intercepting a request of said third computer for said file.

8. The method as described in claim 7 and further comprising:
directing said third computer to said caching computer so as to obtain said file.

9. The method as described in claim 7 and further comprising:
utilizing said intermediate computer as said caching computer.

10. The method as described in claim 1 and further comprising:
utilizing a global communication network to establish said peer to peer relationship.

11. A computer readable medium having computer-executable instructions for performing a method comprising:
establishing a peer to peer relationship between a first computer and a second computer;
receiving a first request for a file of the first computer from the second computer;
conveying said file from the first computer to the second computer;
caching said file.

12. The computer readable medium as described in claim 11 wherein said method further comprises:
receiving a request for said file from a third computer.

13. The computer readable medium as described in claim 11 wherein said method further comprises:
storing said file at a caching computer for access by additional computers that request said file.

14. The computer readable medium as described in claim 11 wherein said method further comprises:
caching said file at a location where said second computer is located.

15. The computer readable medium as described in claim 11 wherein said method further comprises:
receiving a request for said file at said first computer from a third computer.

16. The computer readable medium as described in claim 15 and further comprising:
directing said third computer to obtain said file from said caching computer.

17. The computer readable medium as described in claim 11 and further comprising:
utilizing a global communication network to establish said peer to peer relationship.
